(19) United States
(12) Patent Application Publication
(10) Pub. No.: US 2024/0232071 A1
(43) Pub. Date: Jul. 11, 2024

(54) INFORMATION PROCESSING APPARATUS, INFORMATION PROCESSING SYSTEM, AND INFORMATION PROCESSING METHOD

(71) Applicant: Sony Interactive Entertainment Inc., Tokyo (JP)

(72) Inventor: Hideyuki SAITO, Tokyo (JP)

(73) Assignee: Sony Interactive Entertainment Inc., Tokyo (JP)

(21) Appl. No.: 18/557,063

(22) PCT Filed: Mar. 23, 2022
(86) PCT No.: PCT/JP2022/013501

§ 371 Date: Oct. 25, 2023

(30) Foreign Application Priority Data
May 6, 2021 (JP) 2021-078775

(51) Int. Cl. G06F 12/02; G06F 12/16

(52) U.S. Cl. CPC G06F 12/0246; G06F 12/16

(57) ABSTRACT

An information processing apparatus 10a includes a first SSD drive including a first NAND module and a first flash controller, and a second SSD drive including a second NAND module and a second flash controller. A host unit stores data that is necessary to perform information processing, into either the first SSD drive or the second SSD drive, and the SSD drive in which the data has been stored is switched to a read-only mode in which only a read request is received.

### TECHNICAL FIELD

The present invention relates to an information processing apparatus equipped with a flash memory, an information processing system including the information processing apparatus, and an information processing method.

### BACKGROUND ART

With an increase in capacities of NAND (Not AND) type flash memories, SSDs (Solid State Drives) have come into wide use as a substitute for conventional HDDs (Hard Disk Drives). SSDs have an advantage over HDDs in that a data access to an SSD can be performed at high speed and with low power consumption, but have poor durability against repeated data reading and rewriting. Therefore, to rewrite data in an SSD, a process for designating distributed areas as rewriting targets is performed. For example, if a rewrite request is issued by a host CPU (Central Processing Unit), a designated logical block address is converted to different physical addresses such that areas for rewriting are distributedly set to as many memory cells as possible (see PTL 1, for example).

### CITATION LIST

### Patent Literature

### [PTL 1]

WO 2014/132346A1

### SUMMARY

### Technical Problem

An access to an SSD can be made at high speed, as previously explained. Thus, if much of data which is required for information processing can be read out at a necessary time point, it is possible to reduce the capacity of a system memory. However, if the frequency of making an access is increased, a management processing problem typical of SSDs arises. Examples of management processing are as follows. Specifically, in a case where data is written into various areas in a NAND type flash memory on which overwriting is not allowed, it is necessary to copy the written data into continuous areas in a certain step, and erase data in the vacant areas for future writing.

In addition, it is also necessary to save the data in a different area in a certain step, in order to take countermeasures against a possibility that electrical charge in an element leaks and data is destroyed due to repeated data reading. Further, in order to perform high-speed writing, an SLC (Single Level Cell) in which 1-bit data can be stored in each memory cell is used as a cache, and data in the SLC is transferred at a later timing into a TLC (Triple Level Cell) in which 3-bit data can be stored in each memory cell. When a higher priority is given to the aforementioned management processing than a request from a host CPU, a serious delay time is generated in information processing in some cases. However, if the management processing is not performed at a proper timing, there is a possibility that a request from the host CPU may not be handled.

The present invention has been made in view of the above problems, and an object thereof is to provide a technology of stably performing information processing using an SSD while suppressing a delay time due to a memory access.

### Solution to Problem

A certain aspect of the present invention relates to an information processing apparatus. The information processing apparatus includes a host unit that performs information processing, a memory that stores data for use in the information processing, and a memory controller that makes an access to the memory according to a request from the host unit, in which the memory controller realizes a read-only mode in which only a request for reading of data stored in the memory is received.

Another aspect of the present invention relates to an information processing system. The information processing system includes an information processing apparatus that performs information processing, and a server that provides data for use in the information processing to the information processing apparatus over a network, in which the information processing apparatus includes a plurality of device drives each including a memory that stores the data provided by the server, and a memory controller that makes an access to the corresponding memory according to a request from a host unit, and the memory controller that corresponds to the memory in which the data for use in the information processing has been completely stored, realizes a read-only mode in which only a request for reading of data stored in the memory is received.

Still another aspect of the present invention relates to an information processing method. The information processing method is performed by an information processing apparatus, the method including a step of storing data for use in information processing, into a memory, a step of, after the data storing is completed, bringing the memory into a read-only mode of receiving only a request for reading of data stored in the memory, a step of making a read request to the memory, and a step of performing information processing using data read out according to the read request.

It is to be noted that a method, an apparatus, a system, a computer program, or a recording medium having a computer program recorded therein, which is obtained by translating any combination of the above constituent elements or an expression in the present invention, is also effective as an aspect of the present invention.

### Advantageous Effects of Invention

According to the present invention, information processing using an SSD while suppressing a delay time due to a memory access can be stably performed.

### BRIEF DESCRIPTION OF DRAWINGS

FIG. 1 is a diagram depicting a circuit configuration of a typical information processing apparatus.

FIG. 2 is a diagram depicting a circuit configuration of an information processing apparatus according to the present embodiment.

FIG. 3 is a diagram depicting another example of a circuit configuration of an information processing apparatus according to the present embodiment.

FIG. 4 is a diagram depicting a configuration of an information processing system according to the present embodiment.

FIG. 5 is a diagram depicting a process flow of making accesses to an SSD drive according to the present embodiment.

FIG. 6 is a flowchart of a procedure in which the information processing apparatus according to the present embodiment downloads a necessary file from a storage server, and performs information processing.

FIG. 7 is a flowchart of a detailed procedure of initial processing at S10 and mounting at S12 in FIG. 6.

FIG. 8 is a flowchart of a detailed procedure of mounting in a read-only mode at S16 in FIG. 6.

### DESCRIPTION OF EMBODIMENT

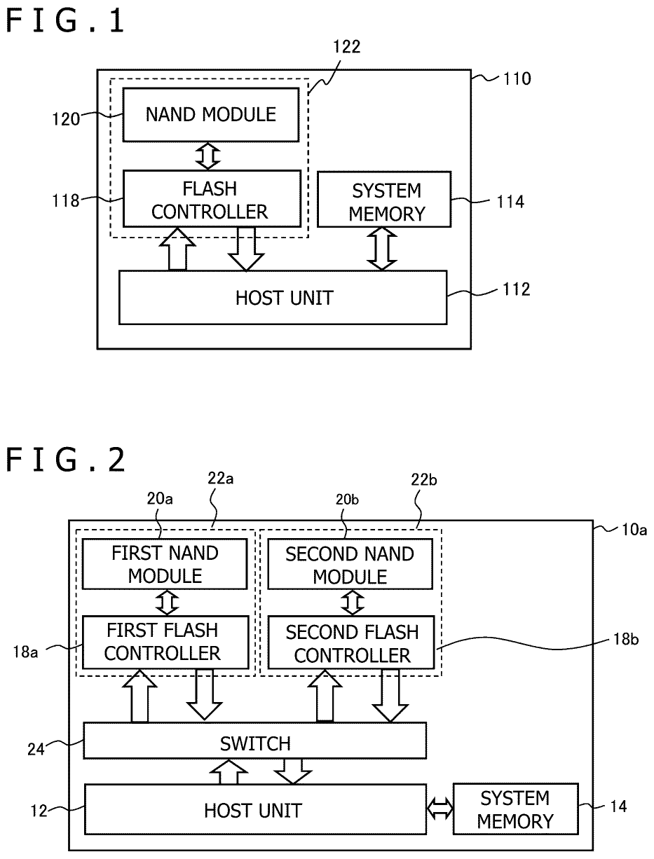

First, a typical information processing apparatus including an SDD will be explained in order to clarify features of the present embodiment. FIG. 1 depicts a circuit configuration of a typical information processing apparatus. An information processing apparatus 110 includes a host unit 112 that includes a CPU, a system memory 114, and an SSD drive 122 that includes a NAND module 120 and a flash controller 118. In the SSD drive 122, the NAND module 120 includes a plurality of NAND type flash memories, and stores data in a distributed manner to a plurality of channels (for example, four channels or eight channels).

The host unit 112 includes a CPU, and loads a program and data stored in the NAND module 120, into the system memory 114, and performs information processing using the loaded program and data. Then, resultant data to be saved is written into the NAND module 120, as appropriate. The host unit 112 further reads out an application program and data from a recording medium being driven by a recording medium driving unit (not illustrated), or downloads an application program and data from a server connected to a network via a network controller, and then, stores the application program and data into the NAND module 120.

During this process, the host unit 112 issues an access request for the NAND module 120 to the flash controller 118. The flash controller 118 adds the issued access request to an access request queue provided in an internal memory or the like. Then, the flash controller 118 performs reading/writing to the NAND module 120 according to an access request sequentially read out from the queue. The access request includes an LBA (Logical Block Address) of an access destination.

A unit of random access that can be designated by the LBA when the host unit 112 makes a random access to continuous address spaces, is 512 bytes, for example. The flash controller 118 translates the LBA included in the access request to a physical address in the NAND module 120. Therefore, the flash controller 118 previously develops, to an internal memory or the system memory 114, at least a part of an address translation table originally stored in the NAND module 120.

Further, the flash controller 118 performs data reading/writing by making an access to an area, in the NAND module 120, corresponding to the acquired physical address with reference to the address translation table. In general, data reading/writing to the NAND module 120 is performed in units (for example, 4096 bytes) specified by a file system.

However, data overwriting is not allowed in a NAND type flash memory. Therefore, in order to update written data, it is necessary to erase original data once. In recent large capacity NAND type flash memories, data is erased in units of several tens of MiB (1 MiB=2²⁰ bytes), for example. Thus, the data erase unit is 1000 or more times as large as a reading/writing unit in many cases. That is, even if the amount of data to be rewritten is small, it is necessary to read out and erase a whole erasing unit of data of a large size, and then write the read data again.

In order to avoid such a situation, the flash controller 118 allocates a new area in the NAND module 120 to data to be rewritten, if rewriting the data is required. Then, the address translation table is updated to bring the physical address of the area into correspondence with the same LBA as that before the rewriting. Accordingly, the number of times of erasing the aforementioned large size data can be reduced. Here, the flash controller 118 regularly erases a used area so as not to cause a shortage of new areas to be allocated, even when rewriting is performed with a high frequency. This is generally referred to as “Garbage Collection.”

Another characteristic of a NAND type flash memory is that reading latency and writing latency are asymmetrical. In an SLC in which 1-bit data is recorded in each memory cell, reading latency is typically 50 μsecs or shorter and writing latency is typically 500 μsecs or shorter. In a TLC in which 3-bit data is recorded in each memory cell, reading latency is typically 100 μsecs or shorter, and writing latency is typically 3 msecs or shorter.

In a case where data writing involves data erasing, the writing latency is approximately 5 to 10 msecs. In a case where the aforementioned garbage collection is performed, the latency of 1 sec or longer may be generated. In general, the flash controller 118 implements, through firmware, a command scheduling function based on these characteristics of NAND type flash memories so that reading/writing latency is maintained at a fixed value or less as much as possible.

For example, data writing into a TLC for which a complicated writing sequence is required takes longer than data writing to an SLC. In general, a part of the NAND module 120 is ensured as an SLC area, and is used as a cache, whereby the speed of data writing is increased. Here, the flash controller 118 copies data written in an SLC into a TLC at a proper timing different from the timing of a writing request. Thus, when the command schedule is complicated, it is difficult to achieve an intrinsic high-speed access performance of a NAND type flash memory because latency of command processing of firmware is also generated.

In view of this, in the present embodiment, two or more SSD drives are provided, and mode switching is controlled to bring at least any one of the SSD drives into a read-only mode such that the latency of data reading is adjusted to a fixed value or less. Complicated command scheduling which is required during writing is not necessary for a drive that is in the read-only mode. Therefore, without involvement of firmware or with minimum involvement of firmware, sequential data reading can be performed, and the latency can be minimized. Further, when a drive that receives both reading and writing is additionally ensured, necessary processing still can be performed in the background or the like.

FIG. 2 depicts a circuit configuration of an information processing apparatus according to the present embodiment. Here, an information processing apparatus 10a is any common information apparatus such as a mobile game machine, a personal computer, a mobile phone, a tablet terminal, or a PDA (Personal Digital Assistant). The information processing apparatus 10a includes a host unit 12, a system memory 14, a first SSD drive 22a including a first NAND module 20a and a first flash controller 18a, and a second SSD drive 22b including a second NAND module 20b and a second flash controller 18b. It is to be noted that the information processing apparatus 10a basically has the similar functions to those in the information processing apparatus 110 depicted in FIG. 1. Hereinafter, the differences from the information processing apparatus 110 will mainly be explained.

The host unit 12, the first SSD drive 22a, and the second SSD drive 22b are connected by PCI Express (PCIe) via a switch 24, for example. PCIe is a connection standard for extension busses and extension slots. According to PCIe, different transmission bands can be used respectively for data reading and data writing. It is to be noted that two SSD drives are provided in the depicted example, but three or more SSD drives may be provided. The host unit 12 loads respective device drivers for the first SSD drive 22a and the second SSD drive 22b, and thereby recognizes the SSD drives separately at different mounting positions.

The host unit 12 basically mounts an SSD drive (e.g. the first SSD drive 22a) in which data on an application that is operated in a foreground is stored, in read-only mode, facilitates progresses in information processing, and generates a display image by reading out various types of data from the SSD drive. To write data such as saved data or additional patch data to be saved, which is generated or downloaded during the information processing, a folder is provided in the other SSD drive (e.g. the second SSD drive 22b) that has been mounted in a read/write mode, and a link thereto is set as a writing destination.

In the “read-only mode” which is a special mode, only a read request is received. In the “read/write mode” which is a general mode, both a read request and a write request are received. When a scene is changed in an electronic game or when an application is finished, the host unit 12 remounts the first SSD drive 22a which has been mounted in the read-only mode, in the read/write mode. Then, into the first SSD drive 22a, the host unit 12 copies data which is included in additional data such as saved data or patch data written in the second SSD drive 22b and needs to be read out with low latency during execution of a next application.

Accordingly, the copied data and the original application data are stored in the same SSD drive. Therefore, when the processing is resumed, high-speed data reading in the read-only mode can be performed. In addition, the host unit 12 may progress the information processing while reading out data from the first SSD drive 22a that is in the read-only mode, and also may download data on another application from a server and store the data into the second SSD drive 22b that is in the read/write mode.

When various kinds of processing accompanying writing of saved data, patch data, or data on another application are performed in the background, necessary processing can be performed without influencing the progress of an application that is under execution in the foreground. When mode switching between the read/write mode and the read-only mode is performed, firmware that is used in a flash controller (e.g. the first flash controller 18a) of a target SSD drive is also switched.

A typical flash controller includes a plurality of microcontrollers such that data reading, data writing, and background jobs, etc. are performed by the microcontrollers in cooperation. In this case, latency may be increased due to overhead of synchronization processing in the microcontrollers. In view of this, in the present embodiment, firmware switching is performed in the read-only mode, as previously explained, and control is performed on one microcontroller such that the microcontroller immediately handles a read request acquired from the host unit 12.

In the read-only mode, the necessity of processes excluding the complicated scheduling and the data reading is small. Therefore, simple processing using one microcontroller can be performed. When mode switching to the read/write mode is performed, the firmware is also changed to the original firmware. When this firmware switching is performed, program data for the switching is reloaded as needed, whereby an internal storage area in the flash controller can be saved.

In addition, other settings of the flash controller may be optimized through the firmware switching. For example, in the read-only mode, the frequency with which the flash controller polls read requests from the host unit 12 may be increased. In addition, in an internal storage area in the flash controller, an area released upon switching from the read/write mode may be used to increase the depth of a queue of read requests. As a result of switching of these settings, latency in handling a read request also can be reduced.

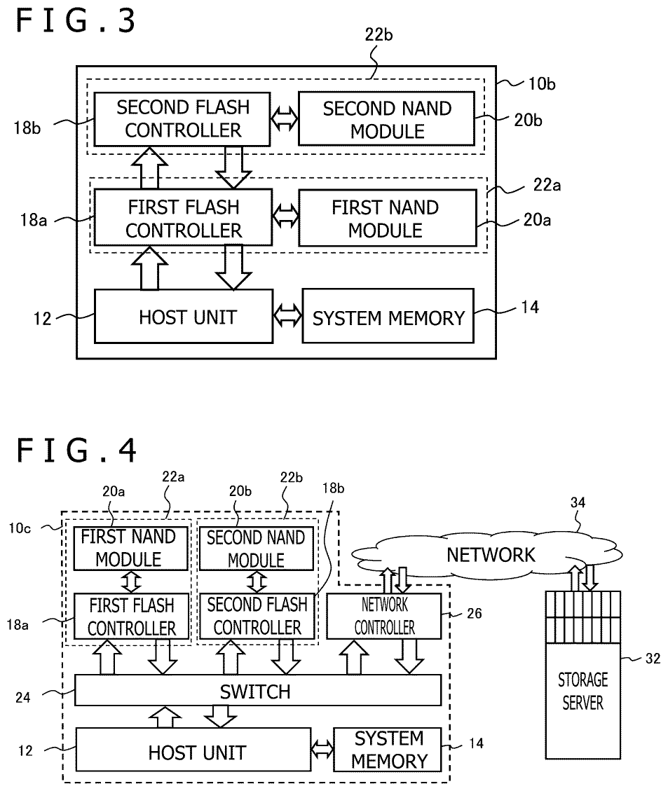

FIG. 3 depicts another example of a circuit configuration of an information processing apparatus according to the present embodiment. In common with the information processing apparatus 10a in FIG. 2, an information processing apparatus 10b in FIG. 3 includes the host unit 12, the system memory 14, the first SSD drive 22a including the first NAND module 20a and the first flash controller 18a, and the second SSD drive 22b including the second NAND module 20b and the second flash controller 18b.

However, the information processing apparatus 10b has a difference from the information processing apparatus 10a in FIG. 2 in that the SSD drives are connected in serial whereas the two SSD drives are connected in parallel with the host unit 12 in the information processing apparatus 10a. That is, the host unit 12 is connected to the first flash controller 18a alone, and the first flash controller 18a is connected to the second flash controller 18b, and thus, cascade connection is established. In this case, an access request issued by the host unit 12 is transmitted between the flash controllers, if needed, and then, a flash controller corresponding to the request performs data reading and writing to a NAND module connected to the flash controller.

With this configuration, the information processing can be progressed with minimum latency, as in the information processing apparatus 10a in FIG. 2. That is, an SSD drive (e.g. the first SSD drive 22a) in which data on an application to be executed in the foreground is stored is used in the read-only mode, so that the data can be read out and processing can be progressed with guaranteed latency. It is to be noted that, also in this case, the number of SSD drives is not limited, and cascade connection among three or more SSD drives may be established.

FIG. 4 depicts a configuration of an information processing system according to the present embodiment. In an information processing system 30 depicted in FIG. 4, the information processing apparatus 10c and a storage server 32 are connected over the network 34. However, the number of the information processing apparatuses 10c (also referred to as calculation nodes) that are connected to the storage server 32 is not limited to a particular number. The storage server 32 may be included in a server that provides a program or data necessary for information processing such as a game application to be performed by the information processing apparatus 10c. The storage server 32 may be a storage array including multiple storages.

In common with the information processing apparatus 10a depicted in FIG. 2, the information processing apparatus 10c includes the host unit 12, the system memory 14, the first SSD drive 22a including the first NAND module 20a and the first flash controller 18a, and the second SSD drive 22b including the second NAND module 20b and the second flash controller 18b. In this example, the first flash controller 18a and the second flash controller 18b are connected to the host unit 12 via the switch 24.

Alternatively, cascade connection may be established between the first flash controller 18a and the second flash controller 18b, as in the information processing apparatus 10b in FIG. 3. In either case, the number of SSD drives is not limited. The information processing apparatus 10c further includes a network controller 26 which is connected to the host unit 12 via the switch 24 and further is connected to the storage server 32 over the network 34.

The network 34 has a peak band width that corresponds to a writing speed to the first SSD drive 22a and the second SSD drive 22b in the information processing apparatus 10c. The information processing apparatus 10c makes an access to the storage server 32 over the network 34, and downloads at least a part of data required for information processing, into the first SSD drive 22a and the second SSD drive 22b. In a game application that includes exceptionally large texture or sound data and 3D data, requirements regarding latency are severe.

Accordingly, in a conventional way, data for immediate use is developed into a system memory of an information processing apparatus as much as possible, and data that cannot be stored is downloaded from a server with a load waiting time clearly displayed, or data expected to be required has been previously read from a server. For example, a load balancer of a server performs control of previously downloading a game title that is popular with a plurality of users, into an information processing apparatus, and downloading a game title that is not so popular, as needed. Accordingly, a load is distributed so as to prevent congestion in the band width of writing into an SSD drive.

Since a read-only mode is introduced in the present embodiment, latency of approximately 200 μsecs, which is much shorter than a rendering time for 1 frame, is guaranteed in data reading. Therefore, without being previously read out, some data can be read out and used in a frame that is being rendered. In view of the fact that a NAND module is capable of storing several hundreds of gigabytes to several terabytes of data, it is possible to previously load the whole data on one game title from the storage server 32, and progress the game using the data with low latency.

For example, the information processing apparatus 10c loads a game title selected by a user from the storage server 32 into the first NAND module 20a, and then, starts the game. When the game is under execution, the first SSD drive 22a is used in the read-only mode. On the other hand, a load balancer of the storage server 32 predicts a game title that is expected to be executed next on the basis of a game title that is under execution at a plurality of computation nodes including the information processing apparatus 10c or a game title that is on standby.

According to the prediction result, the information processing apparatus 10c loads, in the background, the game title that is expected to be executed next from the storage server 32, and stores the loaded game title into the second NAND module 20b that is running in the read/write mode. Since an SSD drive from which data reading is performed is different from an SSD drive to which data writing is performed, the band widths are not influenced by each other, so that the respective peak band widths can be maintained. In addition, the latency in reading and the latency in writing are also not influenced by each other. Accordingly, latency that is equal to or less than a fixed value can be guaranteed.

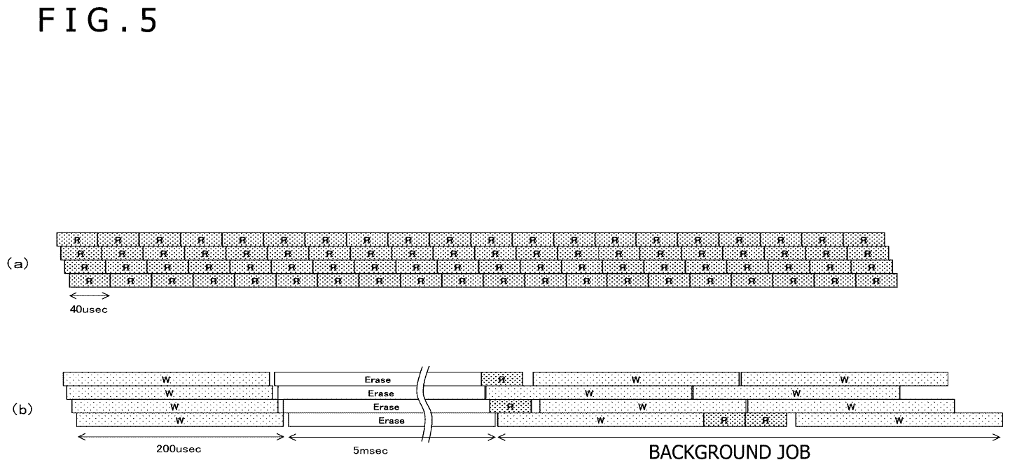

FIG. 5 depicts a process flow of accesses to an SSD drive according to the present embodiment. In FIG. 5, (a) indicates processes that are performed on an SSD driver that is in the read-only mode while (b) indicates processes that are performed on an SSD driver that is in the read/write mode. The horizontal axis indicates a time elapsed, and the length of each rectangular indicates a time period that is taken to perform each process. In FIG. 5, “R,” “W,” and “Erase” represent reading, writing, and block data erasing, respectively.

In this example, it is assumed that an SSD drive includes multiple channels (four channels in FIG. 5), and that data accesses are parallelly made through the multiple channels. In addition, each channel includes a plurality of NAND devices, and selection of a device is made by a chip enable signal. Accordingly, latency that is generated in reading or writing can be concealed.

It is assumed that a NAND device is used in an SLC mode, a time required for data reading is 40 μsecs, a time required for data writing is 200 μsecs, the speed of an interface between a flash controller and a NAND module is 1 GByte/sec, and a time required for data erasing is 5 msecs. In addition, it is assumed that reading/writing is performed in units of 32 KiB when a page size=16 KiB and 2 planes are set. Furthermore, it is assumed that one side of the transfer band width of an interface with the host unit 12 is 6.5 GB/sec. However, the present embodiment is not limited to those numerical values.

In a case where the above numerical values are given, in the read-only mode depicted in (a), an SSD driver handles read requests issued by the host unit 12 in a cycle of 40 μsecs in each channel. The bandwidth of this data reading is 32768/40=819.2 MBytes/sec in each channel. During a data transfer in one channel, a next page is read out through another channel, as depicted in FIG. 5, so that a time required for the transfer can be concealed. For example, if eight channels are provided, the band width is 6.5 GBytes/sec. Thus, use of the transfer bandwidth of the interface with the host unit 12 can be maximized.

On the other hand, in the read/write mode depicted in (b), an SSD driver needs to perform background jobs including data erasing in block units of several tens of MiB and garbage collection, in addition to handling write requests issued by the host unit 12. The band width of data writing is 32768/200=163.84 MBytes/sec in each channel. In a case where 32 devices are provided with four of the devices provided in each of the eight channels, the total band width is 5.2 Gbytes/sec. Accordingly, also during the data writing, the use of the transfer bandwidth of the interface with the host unit 12 can be maximized.

On the other hand, an estimate of latency in the worst case is as follows. For example, to interrupt an SSD drive that is in the read-only mode with a read request of a high priority, latency including a time for reading based on an issued request, a time for reading based on an interrupting request, and a time for transfer of read data, is approximately 120 μsecs. Here, when the size of data to be read is increased, the number of requests simultaneously issued to each of the channels is increased. Thus, latency for waiting for processing is added.

For example, in a case where 1 MiB of data is requested to an 8-channel SSD drive, four requests are issued in each channel. Since 120 μsec which is a waiting time for handling three requests is added, the total latency is 240 μsecs. Likewise, in a case where 32 MiB of data is requested, the latency is 5.2 msecs. When a requested data size is 256 KiB or less, one request is issued in each channel. Thus, the latency is 120 μsecs, as previously explained. Since an overhead for waiting for completion of processing at the host unit 12 is taken into consideration, reading latency of approximately 200 μsecs can be achieved.

On the other hand, to interrupt an SSD drive that is in the read/write mode with a read request of high priority, latency of several msecs can be generated unless an issued write request or an issued data erase request is canceled. However, if a write request or a data erase request is canceled, the latency for a write request becomes significantly long. For this reason, a complicated process of progressing data writing and data erasing after a read request is held for a long time period, is required at a certain future time point.

In the present embodiment, an SSD drive that is in the read-only mode is ensured, whereby data reading is released from the control. Accordingly, the peak performance of data reading only and the peak performance of data writing only can be stably guaranteed. It is to be noted that a high-speed access can be made to an SLC which has been assumed in the above explanation, and the frequency of reading data in the same area can be made lower than that in a TLC. Therefore, there is an advantage that deterioration caused by application of voltage is small. However, the present embodiment is not limited to an SLC, and the similar effect can be provided by a TLC.

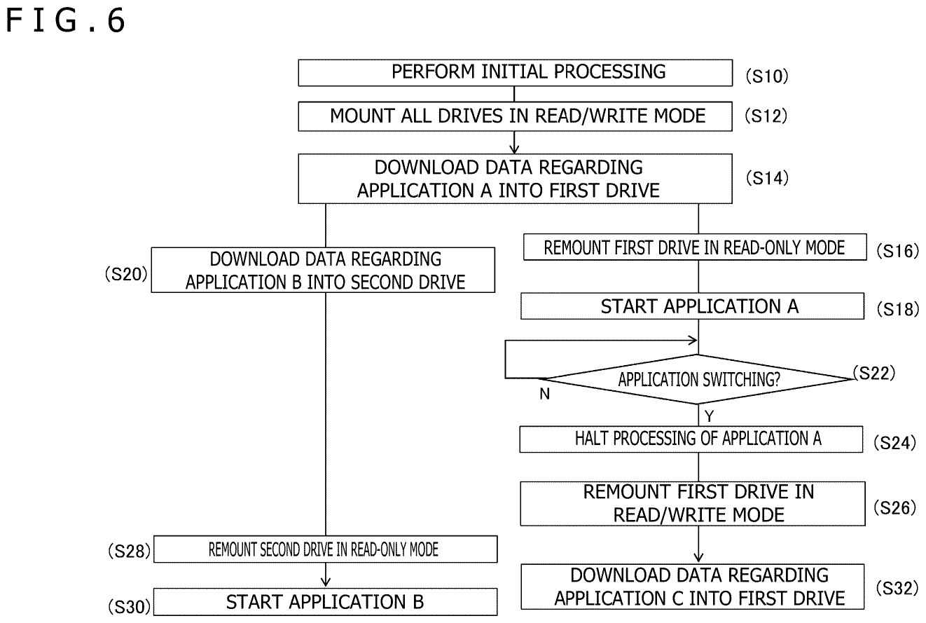

Next, operation of the information processing apparatus which is implemented by the aforementioned configuration, will be explained. FIG. 6 is a flowchart of a procedure in which the information processing apparatus 10c downloads a necessary file from the storage server 32, and performs information processing. In this example, the information processing apparatus 10c includes first and second SSD drives. First, the information processing apparatus 10c performs initial processing (S10), and mounts the first SSD drive 22a and the second SSD drive 22b in the read/write mode (S12).

Subsequently, the information processing apparatus 10c downloads data on an application A to be executed in the foreground, from the storage server 32 according to a user's selection or the like, and stores the data into the first SSD drive 22a (S14). After the whole of the necessary data is stored, the information processing apparatus 10c unmounts the first SSD drive 22a once, and remounts the first SSD drive 22a in the read-only mode (S16). In this step, the first flash controller 18a of the first SSD drive 22a loads read-only firmware to change the internal configuration or settings.

Thereafter, the information processing apparatus 10c starts the application A, and progresses the processing while reading out data from the first SSD drive 22a with guaranteed latency or performance (S18). During this process, in the background, the information processing apparatus 10c downloads data on an application B which is expected to be executed next, from the storage server 32, and stores the data into the second SSD drive 22b that is still in the read/write mode (S20).

Until the necessity for switching to the application B arises, processing of the application A is continued in the foreground (N at S22). When the necessity for switching arises (Y at S22), processing of the application A is halted (S24). Then, the information processing apparatus 10c unmounts the first SSD drive 22a once, and remounts the first SSD drive 22a in the read/write mode (S26). In this step, the first flash controller 18a of the first SSD drive 22a reloads firmware for reading/writing, to change the internal configuration or settings.

It is to be noted that, after bringing the first SSD drive 22a into the read/write mode, the information processing apparatus 10c may copy additional data such as saved data or patch data written in the second SSD drive 22b, into the first SSD drive 22a, if needed, during execution of the application A. Then, the information processing apparatus 10c once unmounts the second SSD drive 22b in which the data on the application B to be executed next has been stored, and remounts the second SSD drive 22b in the read-only mode (S28). In this step, the second flash controller 18b of the second SSD drive 22b loads read-only firmware to change the internal configuration or settings.

Thereafter, the information processing apparatus 10c starts the application B, and progresses the processing while reading out data from the second SSD 22b drive with guaranteed latency or performance (S30). Subsequently, data on an application is downloaded from the storage server 32 while a storage destination is switched, if needed, and further, an SSD drive in which the data has been stored is used in the read-only mode to progress the processing.

During this process, the information processing apparatus 10c may download data on an application C that is expected to be executed next from the storage server 32, if needed, and store the data into the first SSD drive 22a in the background (S20). Subsequently, at least an SSD drive in which data on an application to be executed in the foreground is used in the read-only mode, and further, an SSD drive that is in the read/write mode performs necessary processing that includes writing in the background, in the similar manner.

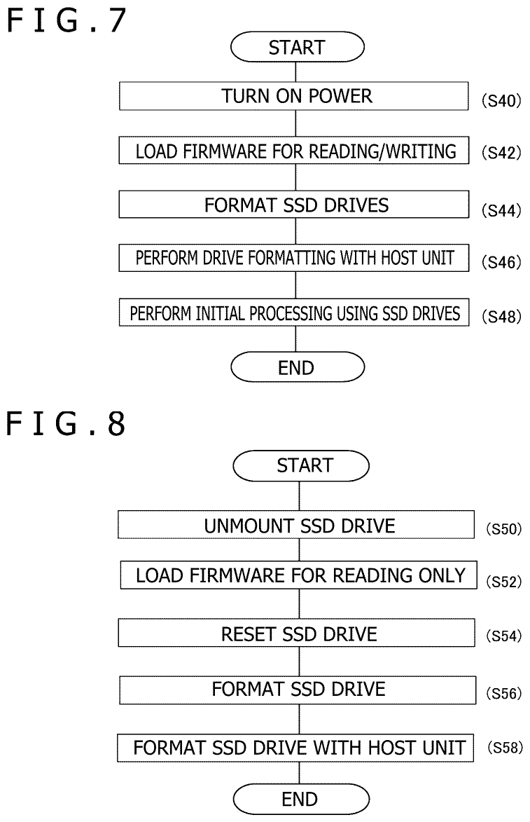

FIG. 7 is a flowchart of a detailed procedure of the initial processing at S10 and the mounting at S12 in FIG. 6. First, the power source of the information processing apparatus 10c is turned on (S40). Then, the first flash controller 18a and the second flash controller 18b load firmware for reading/writing from an internal storage in the information processing apparatus 10c (S42). The storage may be the first NAND module 20a or the second NAND module 20b, or may be, for example, an extra dedicated serial flash device for storing firmware, the dedicated serial flash device being additionally prepared. In this step, the host unit 12 also loads BIOS (Basic Input Output System) from a storage such as a serial flash in the information processing apparatus 10c.

Next, the first flash controller 18a and the second flash controller 18b respectively access the first NAND module 20a and the second NAND module 20b through the loaded firmware, read out various kinds of control information such as metadata in the drives, and format the first SSD drive 22a and the second SSD drive 22b (S44). Next, the first flash controller 18a and the second flash controller 18b accept initial processing from the host unit 12 side (S46).

Specifically, the host unit 12 (BIOS) first loads a device driver for accessing the first SSD drive 22a and the second SSD drive 22b, on the basis of a PCIe device ID (Identifier). With this device driver, the host unit 12 performs various kinds of initialization processing of formatting registers of the first SSD drive 22a and the second SSD drive 22b, and generating a command queue, for example. After the initialization is completed, the host unit 12 is allowed to access the first SSD drive 22a and the second SSD drive 22b. Therefore, the host unit 12 performs necessary initial processing which is loading an operating system, for example (S48).

FIG. 8 is a flowchart of a detailed procedure of the mounting in a read-only mode at S16 in FIG. 6. First, the host unit 12 unmounts the first SSD drive 22a after writing of data on the application A is fully completed (S50). It is to be noted that firmware having been loaded in the first flash controller 18a at this point is assumed to be configured to support a specific command for rebooting the drive in the read-only mode. The same applies to firmware having been loaded in the second flash controller 18b.

Thus, the first flash controller 18a writes out status information regarding the first SSD drive 22a at the unmounting time point into the first NAND module 20a. After the status information is completely saved, the first flash controller 18a loads the read-only firmware from an internal storage of the information processing apparatus 10c (S52), and resets the first SSD drive 22a by making an access to a soft resetting function mapped on an internal register (S54).

After software of the drive is reset, the first flash controller 18a executes the loaded read-only firmware to load the saved status information and various kinds of control information from the first NAND module 20a, and formats the first SSD drive 22a (S56). It is to be noted that, in a case where the PCIe link is disconnected due to the soft resetting of the first flash controller 18a at S54, the host unit 12 detects the disconnection, and unloads the device driver.

When the drive is formatted by the read-only firmware at S56 and PCIe connection is established again, the host unit 12 scans a PCIe tree and reads out the device ID. As a result, the host unit 12 is able to load a proper device driver again. On the other hand, in a case where the PCIe link is not disconnected, a driver that supports both the reading/writing mode and the read-only mode is used. Accordingly, the first SSD drive 22a can be continuously controlled without mode switching.

Subsequently, the host unit 12 formats the first SSD drive 22a again so as to be suited to the read-only firmware (S58). As a result of this, the configuration of the host unit 12 can remount the first SSD drive 22a the configuration of which is different from that for the read/write mode and for which performance guaranteeing setting such as setting of a read-only command queue has been performed.

As a result of the aforementioned processing, the application A and the file system for supporting the application A can satisfy a band and latency required for the application A, with the functions provided by the read-only firmware. To once remount an SSD drive in the read/write mode at S26 in FIG. 6, the drive may be unmounted, and then, be formatted by firmware for reading/writing, in the similar manner as the procedure in FIG. 8.

According to the present embodiment explained so far, a read-only mode is set for an SSD drive that includes a flash controller and a NAND module including a NAND type flash memory, in an information processing apparatus. Accordingly, in this read-only mode, data reading is freed from complicated command scheduling which is specific to the NAND type flash memory and which is required during data writing. In addition, since read-only firmware is used, unnecessary functions are eliminated from a flash controller, and the configuration thereof is simplified. Consequently, read requests issued by the host unit can be handled in order, so that information processing is progressed with minimum and stable latency.

In addition, a plurality of SSD drives are provided, and further, a drive that is in the read/write mode is maintained. As a result, writing processing and various kinds of processing for managing memories can be performed in the similar manner as in a conventional technology. Since an SSD drive for performing these kinds of processing is separate from the SSD drive that is in the read-only mode, there is no influence on the latency and the band width of processing that is being performed in the foreground. For example, since it is not necessary to update image data of a large size which is for use in an electronic game or the like, such image data is suitable for use in the read-only mode. In addition, the necessity of previously reading data is small because the latency is reduced. Thus, a storage area that is required to store read data can be saved, so that the total production cost of the apparatus can be reduced.

The present invention has been explained on the basis of the embodiment. The embodiment exemplifies the present invention, and a person skilled in the art will understand that various modifications can be made to a combination of the constituent elements or the process steps of the embodiment and that these modifications are also within the scope of the present invention.

### INDUSTRIAL APPLICABILITY

As explained so far, the present invention is applicable to a variety of information processing apparatuses including personal computers, game apparatuses, and mobile terminals, and to information processing systems including any one of the information processing apparatuses, and the like.

### REFERENCE SIGNS LIST

10a: Information processing apparatus
12: Host unit
14: System memory
18a: First flash controller
18b: Second flash controller
20a: First NAND module
20b: Second NAND module
22a: First SSD drive
22b: Second SSD drive
24: Switch
26: Network controller
32: Storage server
34: Network

1. An information processing apparatus comprising:
a host unit that performs information processing;
a memory that stores data for use in the information processing; and
a memory controller that makes an access to the memory according to a request from the host unit, wherein
the memory controller realizes a read-only mode in which only a request for reading of data stored in the memory is received.

2. The information processing apparatus according to claim 1, wherein after the data for use in the information processing is completely stored under a read/write mode in which both the read request and a request for data writing into the memory are received, the memory controller brings the memory into the read-only mode, and the host unit issues a read request to the memory that is in the read-only mode so as to progress the information processing using the read data.

3. The information processing apparatus according to claim 2, wherein when performing switching from the read/write mode to the read-only mode, the memory controller switches firmware which defines a process in the memory controller.

4. The information processing apparatus according to claim 3, wherein when switching from the read/write mode to the read-only mode is performed, the host unit remounts a device drive that includes the memory controller for which the firmware has been switched.

5. The information processing apparatus according to claim 2, further comprising:
a plurality of device drives each including the memory and the memory controller that makes an access to the memory, wherein
in a certain time period, any one of the memory controllers realizes the read-only mode while another memory controller realizes the read/write mode.

6. An information processing system comprising:
an information processing apparatus that performs information processing; and
a server that provides data for use in the information processing to the information processing apparatus over a network, wherein
the information processing apparatus includes a plurality of device drives each including a memory that stores the data provided by the server, and a memory controller that makes an access to the corresponding memory according to a request from a host unit, and
the memory controller that corresponds to the memory in which the data for use in the information processing has been completely stored, realizes a read-only mode in which only a request for reading of data stored in the memory is received.

7. The information processing system according to claim 6, wherein
while progressing the information processing using the data read out from the memory that is in the read-only mode, the information processing apparatus acquires data for use in information processing that is expected to be performed next, from the server, and stores the acquired data into the memory of another device drive that is in a read/write mode in which both the read request and a request for data writing into the memory are received.

8. The information processing system according to claim 6, wherein
the information processing apparatus writes data to be saved which is generated during the information processing using the data read from the memory that is in the read-only mode, into the memory of another device drive that is in a read/write mode in which both the read request and a request for data writing into the memory are received.

9. The information processing system according to claim 8, wherein
the information processing apparatus switches the device drive that is in the read-only mode, to the read/write mode at a predetermined timing, and copies the data to be saved, which has been written in the memory of the other device driver, into the memory of the mode-switched device driver.

10. The information processing system according to claim 6, wherein
the plurality of device drives are connected in parallel with the host unit via a switch.

11. The information processing system according to claim 6, wherein
the plurality of device drives are cascade-connected with the host unit.

12. An information processing method which is performed by an information processing apparatus, the method comprising:
storing data for use in information processing, into a memory;
after the data storing is completed, bringing the memory into a read-only mode of receiving only a request for reading of data stored in the memory;
making a read request to the memory; and
performing information processing using data read out according to the read request.
